(19) United States
(12) Patent Application Publication
(10) Pub. No.: US 2025/0232367 A1
(43) Pub. Date: Jul. 17, 2025

(54) PARTNER AND USER GATEWAY TOOL

(71) Applicant: MULTI SERVICE TECHNOLOGY SOLUTIONS, INC., Overland Park, KS (US)

(72) Inventors: Kevin Richard TUCKER, Olathe, KS (US); Daniel Joseph CATES, Overland Park, KS (US); Daniel Wayne ZIMMERMAN, Overland Park, KS (US)

(21) Appl. No.: 18/414,978

(22) Filed: Jan. 17, 2024

(51) Int. Cl. G06Q 40/03; G06N 20/00; H04L 9/40

(52) U.S. Cl. CPC G06Q 40/03; G06N 20/00; H04L 63/08; H04L 63/166

(57) ABSTRACT

A computer-implemented method and system provide for integration and transformation of user and historical data into standardized formats, fostering the intelligent generation of user risk metric scores. These scores play a pivotal role in the automated crafting of personalized lending agreements. These agreements are derived from both lender preferences and predictive analyses of user metrics. Leveraging secure communication protocols, these systems enable the automated execution of lending contracts via smart contract platforms. Additional features of these systems encompass aspects including the automated servicing of buyer-initiated purchases, facilitating transactions on lender credit, and ensuring the streamlined payment to both the seller and the lender.

### BACKGROUND

In the rapidly evolving financial landscape, leveraging technology to streamline and secure lending processes is of paramount importance. Lending applications are submitted by entities to request credit from individual lenders. Each credit application requires a large amount of data retrieval from a variety of sources. Credit applications to multiple lenders can provide for complex and time consuming endeavors.

### SUMMARY

The present discourse delineates revolutionary systems and methods illustrating pioneering advancements in the procurement, processing, and analysis of data critical to modernized financial lending landscapes. This invention stands resilient, offering solutions to prevailing technical hindrances characterized by outdated user interfaces, ushering in a sophisticated approach to consolidate and leverage both historical and real-time data. The detailed approach enhances the efficiency and security in facilitating lending agreements, thereby transmuting the traditionally intricate lending processes into streamlined, user-friendly experiences that are both secure and reliable.

In one aspect of the present disclosure, a robust system involving non-transitory computer storage media and processor(s) is highlighted, where these components work in unison to facilitate a user application's operations through an intelligent, automated process that leverages machine learning. Initiated by a request to authorize a user—which includes a diverse set of application data—the system activates the processor to retrieve and standardize user-associated metrics from a database. It further employs a machine learning algorithm to deduce a risk metric score grounded on these metrics. In progression, it aligns a suitable lender according to predefined criteria and communicates the generated score to this lender using a secure communication protocol. Following lender approval based on the conveyed score, the system autonomously formulates the lending agreement's terms and conditions—governed by a distinct set of rules—prior to initiating the smart contract through a digital platform to ensure the lending agreement's execution, thereby showcasing a harmonized, technology-driven approach to lending processes.

In another aspect of the present disclosure involves a method using one or more processors, dedicated to structuring a user application in the lending domain. It operates by receiving a lender's authorization to initiate the use of one or more lending services. Utilizing a machine learning algorithm, it analyzes historical data and user metrics to craft a set of terms and conditions based on a predictive analysis of a user risk metric score alongside lender preferences. Following this, a lending contract is created by the system, predicated on the previously generated terms and conditions. This contract is then communicated to both the lender and the user for approval. Upon receiving nods of approval from both ends, the system triggers the automated execution of the lending contract, thus finalizing the agreement between the involved parties. This aspect accentuates a predictive, intelligent, and autonomous mechanism in lending contract formation and execution, bridging user requirements with lending services adeptly.

In a further aspect of the present disclosure a system having a processor and computer storage media, is provided to process lending transactions. The architecture is programmed to respond to a request to initiate a lending process, encompassing the assimilation of user-specific application data. A multistep methodology is set in motion where the user's associated metrics are extracted from a database and subsequently standardized. A risk metric score is then sculpted through the machine learning algorithm using the standardized data. Following the analytic phase, the system autonomously discerns the user's eligibility for the services offered by a lender, anchored on the derived risk metric. Culminating this intricate process is the communication of the authorization decision to a graphical user interface, indicating the green light for the user to avail themselves of the lender's services. This aspect enunciates a nuanced, analytical, and user-friendly pathway to lending facilitation, marrying technology with financial prudence effectively.

### BRIEF DESCRIPTION OF THE DRAWINGS

The present technology is described in detail below with reference to the attached drawing figures, wherein:

FIG. 1 is an example operating environment in which aspects of the present disclosure may be employed to process and authorize a merchant credit applicant;

FIG. 2 is an example computing device suitable for implementing aspects of the present disclosure, in accordance with an embodiment described herein;

FIG. 3 is an example process flow that can be performed by components of the operating environment of FIG. 1 and the computing device of FIG. 2, in accordance with an aspect described herein; and

FIG. 4 is a block diagram illustrating example operations that can be performed by the components of the operating environment of FIG. 1, in accordance with aspects described herein.

FIG. 5 is a block diagram illustrating example operations that can be performed by the components of the operating environment of FIG. 1, in accordance with aspects described herein.

### DETAILED DESCRIPTION

In an increasingly globalized world, the need for efficient and cross-border financial transactions has risen dramatically. In the prevailing system, the credit application and lender selection processes largely remain fragmented, operating within a constrained environment defined by geographical and regulatory boundaries. Prospective borrowers typically engage with lenders based on familiarity or limited research, often not having the tools at their disposal to find the most suitable lender for their individual circumstances. The procedure generally requires substantial computer user input (e.g., various queries or searches across the web or excessive user interface drilling), and time, leading to a less efficient process and potentially less favorable terms for the borrowers. Furthermore, the payment and invoicing systems are usually handled separately, creating room for administrative errors and inefficiencies. The current user experience demands a high level of interaction with various interfaces, including detailed searches across the web and navigating through numerous user interface layers, which contributes to increased network/computer latency. This method has substantial room for improvement in terms of network/computer latency, user convenience, and the potential for customized lender-borrower matches. Moreover, borrowers and sellers operating in different countries face even more significant challenges due to the additional layer of complexity introduced by cross-border regulations and differing financial ecosystems. Consequently, there is a pronounced need for a more centralized and streamlined technology that can overcome the current hurdles and modernize the credit application and lender selection process, making it more efficient and globally accessible.

There are various technical problems with existing invoice financing technologies. For instance, current systems grapple with the inability to efficiently integrate historical data and trends, thus rendering the user interfaces and underlying technologies technically inferior in aiding strategic financial decision-making. As outlined previously, a central technical obstacle remains the inefficiency in centralizing data from multiple lenders and disparate financial platforms into a unified platform facilitating invoice financing. Clients and financial institutions find themselves navigating through a maze of information avenues, including different websites, direct communications, and often outdated databases to collect vital details on financing offers, credit terms, and invoice details. This fragmented approach gives rise to significant increments in computer input/output (I/O)—characterized by a surge in physical read/write head activities on non-volatile disks during data operations-thereby being not only time-consuming and prone to errors but also inflicting wear on system components over time. Moreover, users venturing to repeatedly access such dispersed information sources face costly repercussions as the consistent querying consumes vast computing resources. To elaborate, every issued query necessitates the deployment of an optimizer engine in the database manager module to devise an execution plan-a process involving calculations on various parameters such as cardinality and selectivity. This relentless cycle of finding the least costly plan for query execution and execution of multiple credit applications dramatically decreases throughput and elevates network latency, thereby squandering valuable time. Considering that most database relations harbor hundreds or even thousands of records, this recurring calculation on massive rows of data further impedes throughput and amplifies network latency, giving rise to a system that is far from efficient and agile, and which demands for a more streamlined, intelligent, and centralized solution in the invoice financing landscape.

This fragmented approach extends to invoice financing technologies, resulting in substantial time consumption, incomplete information, and the application of a considerable amount of effort, impeding the swift and effective planning and execution of financial operations. The lack of a unified platform that gathers all pivotal invoice financing data in one centralized location—for example, a single user interface page—exacerbates these inefficiencies, introducing potential delays and operational stagnations. Moreover, consolidating comprehensive information into a unified format or user interface that is easily navigable represents a crucial technological advancement over the existing systems. It would not only streamline operations but also foster a more intuitive and user-friendly environment, wherein individuals and institutions can make informed decisions swiftly, leveraging the aggregated data and insights at their fingertips. This represents a marked departure from the current state of affairs, ushering in a new era of efficiency and intelligence in invoice financing technologies.

Another significant technical problem is the deficiency of real-time updates in prevailing invoice financing technologies. The dynamic landscape of invoice financing necessitates uninterrupted access to the most recent data concerning lending rates, credit terms, and offers, among other critical variables. Contemporary systems frequently falter in supplying live data, giving rise to decisions grounded on stale or incorrect information. This issue is further intensified by the dearth of satisfactory visualization tools or user interfaces. Without a robust framework that effectively maps out the comprehensive data of financial offers and pertinent details transparently, users find it laborious to evaluate and juxtapose the myriad options at their disposal. This limitation shackles their ability to forge informed and prompt decisions, standing as a towering obstacle in the path of achieving a seamless and efficient invoice financing experience. Leveraging modern technologies to facilitate a user interface capable of presenting real-time updates and intelligent analytics can pave the way for a revolutionized invoice financing ecosystem, empowering stakeholders with the tools necessary for swift and knowledgeable decision-making.

A further technical problem evident in the present landscape is the absence of systems proficient at seamlessly integrating historical data and fine-tuned user experience within the realm of invoice financing. Recognizing the patterns and trends in the invoice financing sector, such as past transaction histories, prior credit terms offered, and fluctuating lender rates, can confer precious insights beneficial for strategizing and negotiation phases. Regrettably, a substantial number of existing tools and user interfaces come up short in furnishing this vital historical vantage point, thereby forfeiting golden opportunities for leveraging strategic decision-making based on data-backed insights. The essence of user experience, inclusive of attributes like intuitive design, personalized settings, and effortless navigation, is often given insufficient attention in the current scenario. This negligence creates formidable barriers for users, curtailing the overall efficacy of the available platforms. Consequently, it ushers in a landscape ripe with suboptimal choices and overlooked prospects in planning and executing invoice financing strategies. Bridging this gap calls for an evolved technological blueprint that centers around a user-friendly ecosystem, offering not just live data but an intelligent system capable of harvesting historical context to foster informed and strategic financing endeavors.

Leveraging data from a variety of sources and centralizing it into a singular, standardized format or user interface substantially elevates the present technology, enriching the efficacy, precision, and interoperability of information management in the invoice financing sphere. This consolidation into a unified format or interface not only smoothens the pathway for data integration and analysis but eradicates inconsistencies spawned from managing diverse data structures and types. This transformative step facilitates the fluid exchange of information across different platforms and applications, nurturing real-time collaborative decision-making. For stakeholders in invoice financing, including applicants and financial institutions, this innovation means rapid and unencumbered access to essential data concerning loan offerings, applicant histories, and credit terms. This centralization lays the ground for more precise comparisons, trending analyses, and forecasts, enhancing the overall quality of financial planning and operations in the sector. Thus, the unified data format emerges as a technological linchpin, forging connections between various data reservoirs and augmenting the operability and usability of invoice financing systems. It aims to engender a more streamlined and intelligent approach to data handling, thereby standing to significantly revolutionize the invoice financing landscape.

The present disclosure unveils a centralized platform designed to streamline the operation within the invoice financing sphere by consolidating crucial information from various sources into a single user interface page. This platform houses a rich database of information including but not limited to, applicant data, financial offerings, and transaction histories, effectively acting as a one-stop destination for all pertinent data, thus tackling the issue of fragmentation seen in traditional approaches. Leveraging at least one processor and computer storage media, the system deftly retrieves and arranges data in an organized manner within a database. This endeavor goes a step further by visualizing the collated data in a user-friendly manner. Therefore, this innovation stands as a substantial upgrade to the existing state of the art, promising users a more intuitive and seamless experience in navigating the complex landscape of invoice financing.

The aspects delineated herein delineate a system devised to confront the prevalent issues of inefficiency and lack of centralization rampant in the current invoice financing landscape. This innovation hinges on the utilization of at least one processor and computer storage media harboring instructions. This sophisticated setup empowers the system to fetch and assemble crucial metrics pertaining to various stakeholders including lenders, sellers, buyers, and prospective credit users, cultivating a rich repository of indispensable data. This comprehensive assemblage of information is then harmoniously integrated into a database, potentially unified under a singular format or presented through a one-stop user interface page. Venturing beyond mere data compilation, the system leverages the processor to conceptualize a visualization tool that may depict varying aspects of the invoice financing ecosystem coupled with pertinent metrics, thus granting users an enriched, bird's-eye view of the operational landscape. In doing so, it significantly trims down the exhaustive time and effort historically spent sifting through disconnected data sources, thereby redefining ease of access to vital services in the invoice financing space.

By consolidating such information and processes into a singular, centralized system, the innovation drastically curtails the tedious processes of extensive searches, multiple page navigations, and complex route explorations that clients in the invoice financing sector previously had to endure. This pivotal shift not only amplifies user navigation speed, ushering in a fluid and streamlined user journey but also eradicates the strenuous experiences historically associated with such operations. Furthermore, the unification of this wealth of data into a standalone database or user interface page ingeniously diminishes computer Input/Output (I/O) demands, thereby reducing the strain on computational resources. This meticulous arrangement concurrently tackles the issue of network latency, a persistent hurdle in the existing setups, facilitating a swift, responsive, and essentially smoother operational conduit, enhancing the overall user experience manifold in the invoice financing landscape. Regarding I/O, there are fewer read and writes to a storage device because all the information is consolidated into a single data store so the read/write head or other storage access component only has to reach out to a storage device a single time (or fewer times) relative to a storage access component that has to reach out to a storage device multiple times for each unit of data. Regarding network latency, there are fewer query execution plans that are generated to fetch records and thus an optimizer engine is performing less computational overhead (e.g., less selectivity calculations). There is also reduced network latency because only a single database is accessed, as opposed to several databases of disparate information (which may occur because a user traditionally has to perform multiple search queries at a browser for different sets of data). There is also reduced network latency because there are fewer communication channels opened since the data is more centralized at a single database. This means, for example, that there is less TCP/IP or other network protocol packets being sent over a network and less handshaking, thereby reducing network latency.

By integrating both historical and real-time data, the current disclosure unveils a robust solution to the prevailing issue of utilizing outdated information in invoice financing. The initiative meticulously monitors ongoing market trends while accessing a repository rich with historical data, including transaction activity, credit availability, and dynamic discount offers, to estimate the prevailing conditions in the market. This strategy ensures a comprehensive perspective, aiding stakeholders in crafting well-informed strategies and decisions. This dynamic system adapts based on real-time and historical data, surpassing the limitations of existing tools that remain static and disconnected from fluctuating market conditions, hence fostering strategic and adaptive planning in invoice financing.

Furthermore, the systems and methods described ensure the constant updating of various pivotal metrics, providing users with real-time information to facilitate informed and timely decision-making, thereby solving the longstanding issue of outdated data in the current solutions available in the industry. This innovation transcends the technical limitations of previous approaches, offering a streamlined and user-centric platform that enables stakeholders to make decisions that are both effective and grounded in the most recent data, drastically improving the strategic planning and execution process in the invoice financing sector.

In one innovative facet elucidated herein, the invention incorporates a storage medium capable of accessing a database to retrieve various metrics pertinent to invoice financing, encompassing historical data on credit applicant activity, contractual availability, and the dynamism of discount offers. This approach fosters a richer understanding by combining historical trends and real-time insights, promoting informed decisions based on a rich amalgamation of past trends and present circumstances.

Elaborating further, the method introduced accesses a database to extract live data on crucial features such as contractual obligations and the latest discount offers available in the invoice financing arena. This method prioritizes live data, enhancing the user experience by ensuring that decisions are grounded in the most recent and relevant information. This approach not only overcomes the hurdles of outdated data and subpar visualization encountered in current solutions but also paves the way for timely and effective strategy formulation in the invoice financing landscape, signifying a substantial advancement in operational efficiency and user satisfaction

It will be realized that the method previously described is only an example that can be practiced from the description that follows, and it is provided to understand the technology and recognize its benefits. Additional examples are now described with reference to the figures.

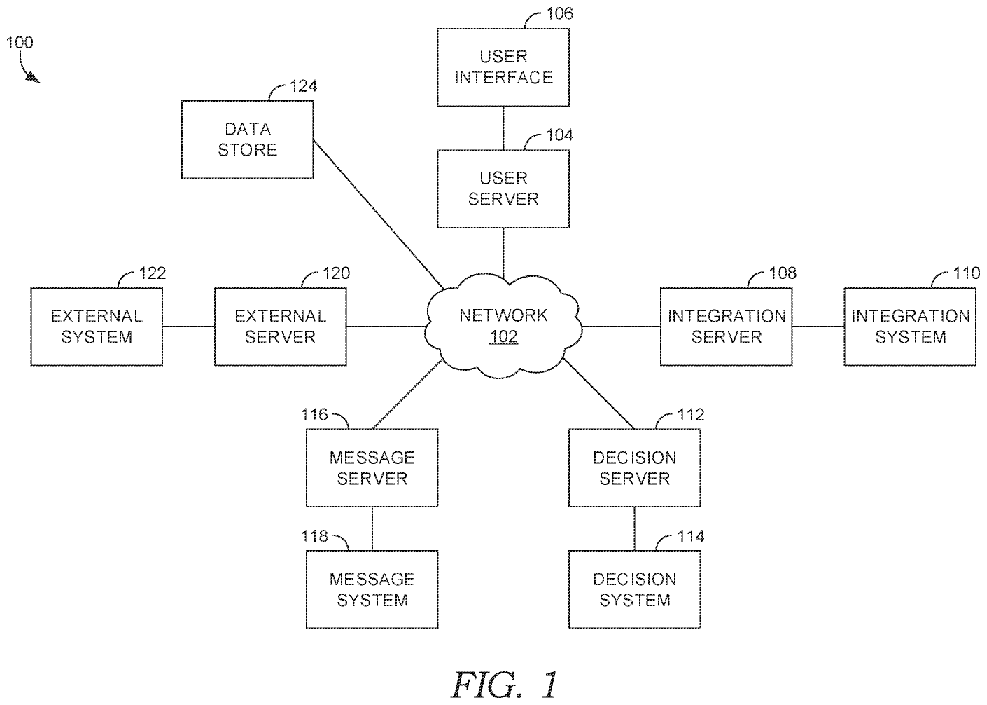

With reference now to FIG. 1, FIG. 1 is an example operating environment 100 in which aspects of the present disclosure can be employed to process and authorize a merchant credit application. As illustrated, the operating environment 100 comprises a network 102, a user server 104 associated with a user interface 106, an integration server 108 associated with an integration system 110, a decision server 112 associated with a decision system 114, a message server 116 associated with a message system 118, and an external server 120 associated with an external system 122 that can communicate with other components of FIG. 1 through the network 102.

The network 102 may include one or more networks (for example, public network or virtual private network “VPN”). In a non-limiting example, the network 102 may include one or more local area networks (LANs), wide area networks (WANs), or any other communication network or method. Each of the components in FIG. 1 may communicate directly or indirectly with other components through the network 102.

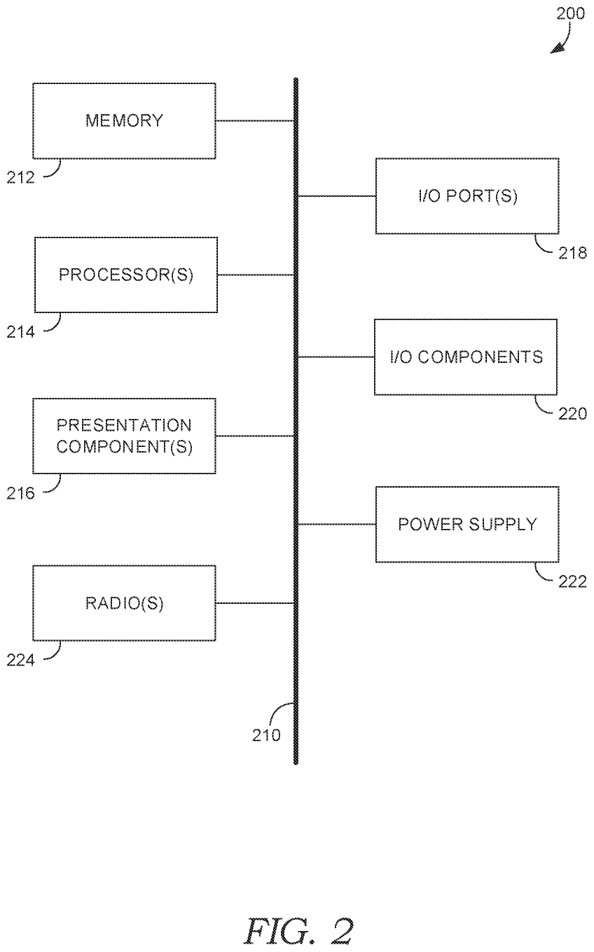

The operating environment 100 further comprises a data store 124. The data store 124 generally stores information including data, computer instructions (for example, software program instructions, routines, or services), or models used in the embodiments of the present disclosure. Although depicted as a single data store component, the data store 124 s embodied as one or more data stores or is in the cloud or other distributed architectures. One example suitable for use as the data store 124 is memory 212, discussed with reference to FIG. 2.

The data store 124 may include one or more storage devices configured to collect, store, delete, update, and/or modify data in accordance with one or more instructions received from one or more other components, the user server 104, the integration server 108, the decision server 112, the message server 116, and the external server 120. For example, the data store 124 may include any suitable combination of one or more storage mediums, such as hard disk drives, solid-state memory, cloud-based storage devices, etc. In various aspects, the data store 124 may store data in addition to or instead of data stored locally by the user server 104, the integration server 108, the decision server 112, the message server 116, and the external server 120. In doing so, the user server 104, the integration server 108, the decision server 112, the message server 116, the external server 120, the data store 124, and/or other backend components may store any suitable type of data used to facilitate various functionalities of certain aspects, as described herein.

Having identified various components of the operating environment 100, it is emphasized that any additional or fewer components, in any arrangement, may be employed to achieve the desired functionality and are within the scope of the present disclosure. Although the various components of FIG. 1 are shown with lines for the sake of clarity, the lines can illustrate a direct path of communication from one component to another or may represent a path where other intermediary components are present.

While the components of FIG. 1 are depicted as single components, the depictions are intended as examples in nature and in number and are not to be construed as limiting for all implementations of the present disclosure. Other arrangements and elements (for example machines, interfaces, functions, orders, and groupings of functions, etc.) can be used in addition to or instead of those shown, and some elements may be omitted altogether. As non-limiting examples, while the user server 104, the integration server 108, the decision server 112, the message server 116, and the external server 120 are each illustrated as a single server, it will be understood that each illustrates one or more servers working with one another in any arrangement. As another example, the data store 124 may illustrate one or more data stores provided in any arrangement throughout the operating environment 100. This may include one or more data stores 124 specifically associated with, and in communication with, each of the user servers 104, the integration server 108, the decision server 112, the message server 116, and the external server 120 to provide data and computer-usable instructions to each of their respective components. Therefore, for the sake of brevity and clarity, when the components of FIG. 1, or any other figure, are referred to in the singular, it is intended to include functions performed by one or more components working together.

The functionality of the operating environment 100 can be further described based on the functionality of the described components. That is, many of the components described in relation to FIG. 1 are entities that perform functions. Various functions described herein are being performed by one or more components and may be carried out by a hardware, a firmware, and/or a software. That is, functions performed by the components of FIG. 1 can be performed by executing computer-executable instructions stored in memory, such as the data store 124.

In general, a server, such as the user server 104, the integration server 108, the decision server 112, the message server 116, and the external server 120, comprises a processor in communication with computer-readable media. The processor executes instructions on the computer-readable media. As previously discussed, the servers illustrated as single servers can be one or more servers working to execute a particular described function.

In one aspect, the user server 104, the integration server 108, the decision server 112, the message server 116, and the external server 120 may be implemented as any suitable number and/or type of a computing device (for example, one or more computer servers) configured to communicate with other components, or one or more client interfaces, such as the user interface 106 (or suitable data stores and/or storage devices associated therewith), etc. In various aspects, the servers described above may be configured to process application programming interface (API) service calls, to support one or more applications installed on one or more devices associated with the user server 104, the integration server 108, the decision server 112, the message server 116, and the external server 120, etc.

As illustrated, the operating environment 100 comprises the user server 104 that is associated with the user interface 106 that can be any such user interface that allows the user or merchant to access accounts and pages associated with a merchant credit authorization. The user interface 106 can receive communications via the network 102 and the user server 104 and maintain accounts within the user server 104 in accordance with instructions received within the communications. For instance, the user interface 106 can identify a user's selection and input. The user interface 106 can cause to be displayed messages provided by the message system 118 and any other system that may communicate with the user interface 106 by way of the network 102. The user server 104 may also communicate instructions received from the user interface 106 by way of the network 102 to other servers, such as the integration server 108. The user interface 106 and the user server 104 are associated with the merchant applicant, an external bank, an external data store system, or any other user that may input or provide information to the network 102.

It will be understood that the integration server 108 may perform actions similar to the user server 104 on behalf of the integration system 110. Throughout the present disclosure, the integration server 108, the integration system 110 or integration service, the decision server 112, the decision system 114, the message server 116, the message system 118, the external server 120, and the external system 122 are referred to in terms of particular roles performed within the described example. However, it will also be understood that such servers and systems may perform other roles for different interactions.

It will be understood that the integration server 108 is associated with the integration system 110. The integration system 110 operates in part as a logic system that processes application data from the applicant by way of the user interface 106. The integration server 108 and the integration system 110 may operate in connection with the external system 122, the data store 124, and other systems to query various data stores, request information, or provide information to other systems and servers.

The decision server 112 on behalf of the decision system 114 may perform various activities. For instance, the decision server 112 can receive various datasets from one or more servers by way of the network 102. The decision server 112 operates using a variety of data logic systems including, but not limited to, simple rules-based logic, machine learning algorithms applied to a neural network, decision logic trees, or any other algorithm built and/or trained to make a variety of decisions based on the data provided.

In the present aspects, the decision server 112 is configured to access data from and/or store data to one or more additional data sources stored in the data store 124 that is included as one or more of backend computing devices. Additionally, or alternatively, the decision server 112 may access data from one or more servers, such as the user server 104, the integration server 108, the message server 116, and the external server 120, and/or data provided by one or more users associated with one or more user interfaces 106. In various aspects, any combination and/or subset of the aforementioned data may form a dynamic data set that changes over time as additional data is collected, and that is stored and/or updated in one or more components, such as the user server 104, the integration server 108, the decision server 112, the message server 116, and the external server 120, and transmitted by way of the network 102 and/or accessed by the decision server 112. For example, the decision server 112 may use any suitable portion of the dynamic data set as training data to train a machine learning model.

Once the machine learning model is trained in this way, the machine learning model is applied to data received to identify, predict, or decide various portions related to the processes described herein. Moreover, once such decisions, predictions, or identifications are made, aspects include the decision server 112 to receive results and information from prior transactions and/or events so as to retrain or add additional training data to improve the machine learning model. The machine learning model is described here with respect to the decision server 112 and the decision system 114, but may be used with respect to any server and system described herein. For example, the integration server 108 may implement the machine learning model with respect to data retrieved by the server.

As illustrated, the operating environment 100 comprises the integration server 108 that is associated with the integration system 110. The integration server 108 can receive communications via the network 102 and maintain accounts within the integration server 108 in accordance with instructions received within the communications. For instance, the integration system 110 or the integration service may receive various portions of a merchant credit application and combine the portions into one application to be sent to the decision server 112 and the decision system 114 by way of the network 102. Additionally, the operating environment 100 comprises the message server 116, the message system 118, the external server 120, and the external system 122. Each of these systems and servers may operate in accordance with instructions received and may communicate with other servers and systems by way of the network 102. Each of the servers and systems may also retrieve information from the data store 124.

An example operating environment in which some of the present disclosure is implemented is described below in order to provide a general context for various aspects. Referring to FIG. 2, in particular, an example operating environment for implementing embodiments of the present disclosure is shown and designated generally as a computing device 200. The computing device 200 is an example of a suitable computing environment and is not intended to suggest any limitation as to the scope of use or functionality of the technology, and nor should the computing device 200 be interpreted as having any dependency or requirement relating to any one or combination of components illustrated.

The technology of the present disclosure is described in the general context of computer code or machine-useable instructions, including computer-executable instructions, such as program modules, being executed by a computer or other machine, such as a personal data assistant or other handheld device. Generally, the program modules including routines, programs, objects, components, data structures, etc., refer to a code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 2, the computing device 200 includes a bus 210 that directly or indirectly couples the following devices: the memory 212, one or more processor(s) 214, one or more presentation component(s) 216, input/output port(s) 218, input/output components 220, and illustrative power supply 222. The bus 210 represents what may be one or more buses (such as an address bus, data bus, or a combination thereof).

Although the various blocks of FIG. 2 are shown with lines for the sake of clarity, in reality, delineating various components is not so clear, and metaphorically, the lines would more accurately be grey and fuzzy. For example, one may consider a presentation component, such as a display device, to be an I/O component 220. As another example, processor(s) 214 may also have memory. Such is the nature of the art, and it is again reiterated that the diagram of FIG. 2 merely illustrates an example computing device that can be used in connection with one or more embodiments of the present disclosure. Distinction is not made between such categories as “workstation,” “server,” “laptop,” “handheld device,” etc., as all are contemplated within the scope of FIG. 2 and make reference to the “computing device.”

The computing device 200 typically includes a variety of computer-readable media. The computer-readable media can be any available media that can be accessed by the computing device 200 and includes both volatile and non-volatile media, and removable and non-removable media. By way of non-limiting example, the computer-readable media may comprise computer storage media and communication media.

The computer storage media includes volatile and non-volatile media, removable and non-removable media implemented in any method or technology for storage of information, such as computer-readable instructions, data structures, program modules, or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium that can be used to store the desired information that can be accessed by the computing device 200. The computer storage media excludes signals per se.

The communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information associated therewith. By way of non-limiting example, the communication media includes wired media, such as a wired network or direct-wired connection, and wireless media, such as acoustic, RF, infrared, and other wireless media. Combinations of any of the above should also be included within the scope of computer-readable media.

The memory 212 includes computer storage media in the form of volatile or non-volatile memory. The memory 212 may be removable, non-removable, or a combination thereof. Example hardware devices include solid-state memory, hard drives, optical-disc drives, etc. The computing device 200 includes one or more processor(s) 214 that read data from various entities, such as the memory 212 or the I/O components 220. The presentation component(s) 216 present data indications to a user or other device. Examples of the presentation component(s) 216 include a display device, speaker, printing component, vibrating component, etc.

The I/O port(s) 218 allow the computing device 200 to be logically coupled to other devices, including the I/O components 220, some of which may be built in. Illustrative components include a microphone, joystick, game pad, satellite dish, scanner, printer, wireless device, and the like.

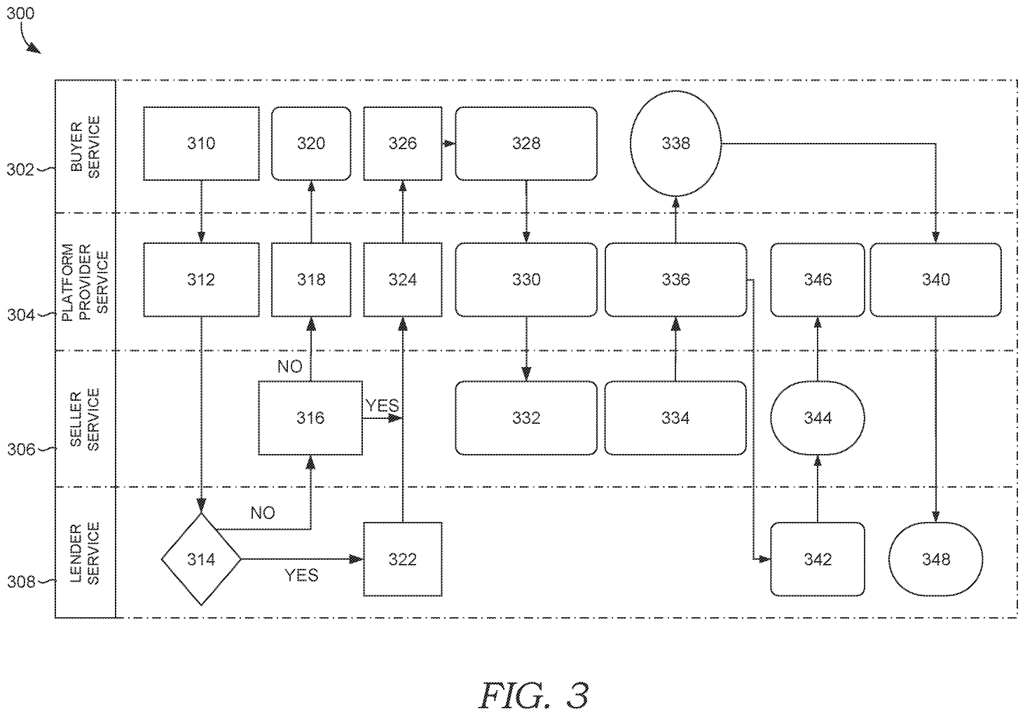

Turning now to FIG. 3, FIG. 3 represents an example process flow 300 that can be performed by components of the operating environment of FIG. 1 and the computing device 200 of FIG. 2, in accordance with an aspect described herein. The process flow 300 comprises a buyer service 302, a platform provider service 304, a seller service 306, and a lending service 308. Each of the services corresponds to one or more servers and systems previously described herein. It is noted that the procedures are examples, and that other arrangements may be possible. All of these aspects, including various other arrangements, will be apparent to those of ordinary skill in the art in view of the present disclosure, and such aspects are contemplated within the scope of the present disclosure. While the process flow 300 is described as a series of steps, it should be recognized that these steps are illustrative and not intended to limit the present disclosure to the specific aspect illustrated in FIG. 3.

Buyer service 302 refers to a technological solution that enables users to apply for various services or programs through a digital platform. The various services or programs referred to could encompass a wide range of financial products, tools, or initiatives offered by lenders and sellers to facilitate smooth transactions and foster customer loyalty. This may include, but is not limited to, credit lines, loans, payment deferment programs, and reward and loyalty programs. Sellers might offer services such as subscription models, premium customer services, warranty programs, or even consultative services to help customers make informed purchasing decisions. The buyer service 302 leverages the processors and digital interfaces to streamline and simplify the application process, making it more accessible, efficient, and user-friendly. Furthermore, the buyer service 302 can use advanced technologies such as data validation, automated checks, and real-time feedback to ensure the accuracy and completeness of the application or payment processes. This helps users identify and correct errors or omissions, reducing the chances of application rejections or delays, or payment issues.

The buyer service 302 can provide an exemplary interface that allows an applicant, a merchant, or a credit issuer to start a credit application by entering data into the user interface. In one example, the buyer service 302 may be a web-based application that requires the user to provide user authentication or identification to access the credit application, purchase goods and services using lines of credit, or providing payment for invoices. The buyer service 302 may also provide selectable and fillable form fields that may detail what is required by the user for an application, a purchase, or a payment. A user inputs information into the user interface. In one aspect, the information is saved or input into the buyer service 302 that may be associated with a database or data store, such as the data store 124 in FIG. 1.

In the back end of the buyer service 302, or any other service provided herein, various technologies work together to handle the processing and management of applications, purchases, and payments. These technologies can include a database management system (DBMS), such as MySQL, Oracle, or MongoDB, to store and manage data. The DBMS ensures secure and efficient storage, retrieval, and organization of application information. Buyer service 302 systems integrate with external APIs, or other services' APIs to gather additional information or perform verification processes during the application review. APIs allow seamless communication with external services such as credit bureaus, identity verification services, or document validation services. Platform provider service 304 may also incorporate authentication mechanisms, such as open authorization (OAuth) or JSON Web Tokens (JWT), to ensure secure access to the platform provider service 304. OAuth is an open standard for access delegation commonly used in token-based identity verification. It allows an application to access specific information from a user's account on another service, without needing to share the user's password or other sensitive information. This system enhances security and privacy by allowing the user to grant limited access to their data hosted on one platform to another platform in a controlled manner. They implement encryption protocols (e.g., SSL/TLS) to protect data transmission and employ security measures to prevent unauthorized access or data breaches between the various services.

In some examples, any one of the services such as buyer service 302, platform provider service 304, seller service 306, or lending service 308 can communicate with external services through various mechanisms such as web APIs, protocols, and data formats. The services can use REST, SOAP, and/or event messaging for communication with external services. The service's API can use representational state transfer (REST) principles to communicate with external services. The API sends requests to the external service's endpoints, receives responses in JSON or XML format, and processes the data accordingly. A SOAP (Simple Object Access Protocol) may be used for exchanging structured information over web services. The API can send SOAP requests to external services using XML-based messages. SOAP APIs often use Web Services Description Language (WSDL) files to define the operations and data structures.

In further examples, any one of the services such as buyer service 302, platform provider service 304, seller service 306, or lending service 308 can communicate with any one of the other services through a secure communication protocols. The secure communication protocol in the disclosed claim refers to a series of predetermined rules and standards that govern the transmission of data between the processor and the first lender. This protocol ensures that the data, which in this case includes sensitive financial metrics and risk scores, is transmitted securely and remains confidential, maintaining its integrity and safeguarding it from unauthorized access. The security may be facilitated through robust encryption methods, which make use of cryptographic keys to encrypt the data before transmission and decrypt it upon receipt. In addition, the protocol may employ authentication mechanisms to verify the identity of the entities involved in the transmission, thereby avoiding impersonation and ensuring that the data is received by the intended recipient. The secure communication protocol might leverage existing protocols such as transport layer security (TLS) or secure sockets layer (SSL). Implementing such a protocol not only underscores the non-abstract and technically grounded embodiment of the invention but also serves as a pivotal function in maintaining the trust and security that is paramount in financial transactions. Within the secure communication protocol outlined herein, an established set of stringent digital rules and cryptographic techniques are operational to facilitate the secure transmission of a wide range of data, including application data and financial metrics, between the processor and the primary lender. This process is initiated with the employment of advanced authentication mechanisms, leveraging multi-factor authentication (MFA) and public key infrastructure (PKI) to ascertain and validate the identities of the participating entities robustly, mitigating risks associated with unauthorized access and impersonation.

The protocol further can use high-grade encryption algorithms. These algorithms operate by applying cryptographic keys that transform the data into an unreadable format, decipherable only by entities possessing the corresponding decryption keys. In particular, it utilizes symmetric encryption for speed during the bulk encryption of the transmitted data and asymmetric encryption for securely exchanging the keys needed to decrypt the transmitted data.

These cryptographic protocols function to secure communications over a computer network within a secure channel, thus preventing eavesdropping, tampering, or message forgery. This is achieved by encrypting the data packets that are sent over the network, ensuring a secure and confidential data transmission pipeline. End-to-end encryption provides an impermeable layer of security where only the communicating parties hold the necessary cryptographic keys to decrypt the transmitted information. The security certificates used in TLS/SSL include the public key and the identity to which it is associated, presenting a secure pathway for the transmission of data wherein the identity of the communicating parties can be validated, a mechanism that prevents man-in-the-middle attacks effectively.

Moreover, to further enhance the security spectrum, the system employs digital signatures, a cryptographic technique that provides non-repudiation. This is a pivotal feature as it ensures that a communicating party cannot later deny the authenticity of the message they sent or received. The digital signatures function by creating a unique hash of the message and encrypting it with the sender's private key. This encrypted hash along with other information such as the hashing algorithm is the digital signature. The receiving party can use the sender's public key to decrypt the hash and compare it with the hash of the received message to verify both its source and integrity. By integrating TLS/SSL protocols and digital signatures, the communication protocol exhibits a fortified stance against potential security breaches, ensuring that the transactional communications are secure, authenticated, and verifiable, establishing a non-abstract and technically grounded foundation integral to the claims.

Additionally, the communication channel itself is fortified by leveraging transport layer security (TLS) or secure sockets layer (SSL). Moreover, the communication channel employs digital signatures to provide non-repudiation, ensuring that a party to the communication cannot deny the authenticity of the message they sent or received. At the database level, security measures such as firewalls, intrusion prevention systems, and regular security audits are conducted to enhance the security infrastructure further. The intricate system not only maintains a record of transactions to facilitate audits and ensure compliance with regulatory standards but also constantly updates itself to adapt to emerging security threats, thus offering a dynamic and robust security framework that is technically grounded.

At step 310, a user can access the buyer service 302 to fill out a credit application, wherein the credit application is for a user to apply for a line of credit with one or more lenders. The details that the user is required to provide during the application can be customized based on various parameters including the user information, seller information, merchant information, lender specifics, country regulations, and the currency involved. The user may select a specific lender or the lender may be selected for the user based on various user parameters such as country, seller, or other parameters. The platform provider service has access to a plurality of lending services and may use any one of them at the lending service 308.

The application customization enables a tailored approach, helping in smoothing the pathway for loan approval by catering to the specific requirements and preferences of the lender, and adhering to the financial regulations pertinent to the buyer's geographical location. Additionally, a dynamic form, capable of adapting based on predetermined parameters such as lender specifics, regional regulatory frameworks, and currency denominations, is presented to the user. This dynamic configuration is able to adapt and configure the form such that the requisite fields and validations are provided based on the input parameters, ensuring adherence to the diverse set of requirements that might be presented by different lenders or regions. For example, some regions, countries, or lenders may require different inputs and the form or application can adapt based on the parameters input.

Upon submission, the credit application triggers a series of events at the platform provider service 304. At step 312, a validation protocol is activated where the integrity and completeness of the data provided in the application are verified. Following validation, a decisioning engine utilizes a multi-faceted analytical approach leveraging data such as lending history, geographical limitations, market dynamics, and regulatory considerations to route the application to the most suitable lender. Additional data may be requested from external sources. Such additional data can be information related to the user's credit, the user's personal information, seller information, market information, country limitations, or other data required or useful for analyzing the application.

In this process, a suitable lender is identified based on the application data using a predetermined set of criteria. After the receipt of the application data, which encompasses detailed financial and personal information about the potential borrower, the platform provider service 304 initiates a detailed analysis using the predetermined criteria, which can include a lender's preferences, historical lending behaviors, financial thresholds, geographical constraints, and other pertinent details. The platform provider service 304 can use analytics and machine learning algorithms to analyze a plurality of lenders, narrowing down to the one lender whose lending parameters align most harmoniously with the applicant's financial profile and loan requisites. The loan requisites can include currency form, geographical constraints, language requirements, term requirements, payment forms, or other requirements. This stage ensures that the selected lender is not just suitable, but optimally matched, thereby substantially increasing the probability of loan approval and fostering a lending agreement that is mutually beneficial and aligned with both parties' expectations and capabilities.

The lending service 308, operates in part as a deaccessioning service, approving or rejecting submitted credit applications. This service can be a variety of financial entities including but not limited to banks, credit unions, private lenders, or other financial partners. It may represent a singular financial institution with a robust financial background, equipped to handle a large volume of transactions with diverse portfolios. Alternatively, it might denote a consortium of smaller lenders pooling their resources to fund a wide array of applications. Additionally, it could signify a financial partner that leverages technology to streamline the lending process.

The lending service 308, at step 314, relies on the platform provider service 304 for the comprehensive analysis and preparation of a credit application. The provider service 304 can use a deep learning model to evaluate the application, incorporating a blend of heuristic analyses and predictive modeling. This analysis assesses potential risks and the feasibility of credit approval. The analysis extends beyond the basic data in the application, encompassing unstructured information obtained from market trends and economic indicators.

The platform provider service 304 provides the lending service 308 with insights such as risk analysis, risk metrics, credit scores, and credit histories, among other factors. These insights are used in the lending service's 308 decision-making process to approve or deny credit. Moreover, the provider service 304 actively gathers and evaluates additional external data from various sources to ascertain a comprehensive risk factor. This includes identifying and analyzing multiple data points related to the credit applicant, buyer, or user, and utilizing machine learning algorithms to calculate a risk metric. Consequently, the lending service 308, equipped with these insights from the provider service 304, makes the final decision on whether to grant credit to the user.

In some aspects, the machine learning algorithm operates dynamically, being continually refined with new data inputs to enhance its predictive accuracy. Initially, the algorithm is trained with a substantial dataset that contains varied examples of credit applications alongside their outcomes (approved or denied), incorporating not just the hard data from the applications but also an array of external data points which could range from market trends to economic indicators. Over time, the system learns to identify patterns and correlations that influence creditworthiness, potentially even uncovering non-obvious relationships through deep learning techniques. Moreover, the algorithm can be periodically re-trained with fresh datasets to ensure it evolves with changing market dynamics, retaining its efficiency in analyzing and predicting potential risks associated with credit approvals effectively. Additionally, the machine learning model may be re-trained based on the current application's data and outcome. As such, it has the capability to integrate this real-time data into its analytical framework.

At step 316, if credit is denied, the seller service 306 is provided the option to opt in for seller approved and backed financing or the approval of self-financing on behalf of the user applicant. This involves triggering a series of automated notifications empowering the seller service 306 on whether to assume the credit risk themselves or opt for a self-financing schema, a decision facilitated through an intelligent dashboard offering insights and analytics on the buyer's credit history and the transaction specifics. This dashboard provides information gathered by the platform provider service 304 and the lending service 308. The decision at step 316 will then be communicated to the buyer service 302 at step 318.

Conversely, at step 322, the lending service 308, based on an approval of a line of credit, information provided in the application, and information gathered by the lending service 308 and the platform provider service 304, can determine a credit limit for the user. The credit limit determination leverages predictive analytics grounded in historical data and potential future economic trajectories. In one example, the lending service 308 initiates a review of the structured data present in the application, which includes the applicant's credit history, employment details, income, and existing debts, among other factors. Subsequently, the lending service 308 can use the deep learning model to examination the unstructured data, which can be harvested from a range of external sources. This could involve sentiment analysis on social media platforms and forums to understand the applicant's reputation, spending habits, and lifestyle choices. Analyzing large datasets of market trends and economic indicators further allows the system to assess the potential risk of lending in the current economic climate. Simultaneously, heuristic analyses involving using experiential techniques to gauge potential creditworthiness, drawing from histories of behavioral and transaction data to make informed predictions are used to facilitate a dynamic risk assessment. Next, predictive modeling techniques are used to simulate various economic scenarios and their potential impacts on the applicant's ability to repay. For instance, stress tests could be run to foresee how economic downturns or increases in interest rates might affect the applicant's financial stability. After assimilating all the data and analysis, the lending service 308 can use artificial intelligence or machine learning to compute a risk metric. This metric takes into account the applicant's financial history and a broader set of variables drawn from deep and extensive data analysis. Finally, the lending service 308 can use a set of predefined algorithms to arrive at a credit limit that balances risk and opportunity effectively, thus optimizing the potential for successful repayment while mitigating the lending risk for the service provider.

In step 324, the platform provider service 304 initializes the formulation of a lending agreement's terms and conditions, predicated on a data-driven analysis of the buyer's historical financial patterns. Leveraging artificial intelligence (AI) systems equipped with deep learning algorithms, this phase encompasses a rigorous analysis of transaction histories and fiscal behaviors to extrapolate viable preliminary lending terms. The analysis entails dissecting granular data such as repayment timelines, purchase frequencies, and the categorization of previous acquisitions to generate a detailed buyer profile that provides for the terms.

The ensuing stage involves an analysis of the applicant's financial and personal credentials, enforcing a level of authenticity and stability requisite for the prospective financial engagement. This segment leverages Natural Language Processing (NLP) algorithms to mine relevant data from various unstructured sources, thereby fabricating a multifaceted applicant profile that becomes instrumental in delineating appropriate lending parameters. The analysis encompasses the verification of vital metrics including, but not limited to, credit scores, asset portfolios, and existing liabilities. Parallel to the applicant's data aggregation, an analytic process is instituted to discern the lender's operational constraints and risk appetite through the continual application of machine learning algorithms. This machine learning model is trained to adapt and evolve based on real-time market feedback, fostering an adaptive blueprint for prospective transactions that align with the lender's thresholds and preferences.

The final stage of this process engages in a comprehensive integration of auxiliary data elements, including geopolitical indices, market trends, and regulatory stipulations, which could significantly influence the lending agreement. This stage facilitates the deployment of big data analytics tools to gauge the potential ramifications of fluctuating economic indices on the agreement's terms. Predictive analytics are leveraged to simulate potential future trajectories based on the prevailing data landscape, enabling a robust risk mitigation strategy grounded in data-backed foresights, thereby generating a lending agreement primed to foster a sustainable financial partnership.

In a further embodiment, following the successful execution and fulfillment of the lending agreement mediated through the smart contract platform, a pivotal feature facilitates the accumulation of feedback from both the lender and the user. This iterative feedback process is integral to nurturing a self-evolving system predicated on continuous improvement and optimization. Utilizing this rich repository of real-world feedback data, the machine learning algorithm undergoes a further training process, enhancing its predictive accuracy and efficacy for future lending contracts. Essentially, the algorithm refines its understanding of risk metrics and lender preferences, progressively honing its ability to stipulate terms and conditions that resonate with both parties' expectations and financial behaviors. Upon the completion of the aforementioned analytic procedures, the platform provider service 304 leverages the data to generate a lending agreement's terms and conditions. Drawing upon the intricate buyer and lender profiles crafted through deep learning and AI analyses, alongside the macroeconomic indicators and regulatory norms, a harmonized draft, fine-tuned to align with both the lender's and buyer's predispositions and regulatory requisites, is conceived.

At step 326, the buyer service 302 configures the finalization of a user account including the linking of a user bank for payment. The buyer service 302 allows for the linking of a bank to the user account, finalizing the account setup, and agreeing to the generated terms and conditions. In this step, the integration of an API facilitates a real-time synchronization with various banks and financial institutions, thereby enabling the automatic retrieval and verification of the banking details provided by the buyer. The API can use machine learning algorithms or other algorithms to verify provided bank account details, scrutinizing the validity of the account number, the bank's IFSC code, and other pivotal details through a series of cryptographic hash functions designed to prevent fraudulent activities. Other algorithm used can be rule-based systems that follow predefined criteria to validate account details or cryptographic techniques that secure and authenticate data. The algorithms might also be statistical models analyzing patterns and anomalies in the data to ensure its validity.

At step 328, the user may initiate a purchase from a seller using the approved line of credit. The user can access their account that has been linked to both their approved credit by the lending service 308 and their banking information. The user may then provide a purchasing order or order directly from the seller service 306. During this step, a secure login mechanism may be implemented leveraging technologies such as OAuth 2.0 for secure, token-based user authentication. Once logged in, the user interacts with a dynamic user interface. Additionally, the buyer's profile can be monitored to provide the user or buyer previously set credit limits, available balance, and banking details from the platform provider service 304. The buyer or user can select the seller and the products or services desired from a list or interactive user interface. Once the products or services are selected, the buyer can finalize the purchase and an order is created. The purchase can be from a single seller or it can involve multiple sellers. For example, the buyer can select a single product from a first seller and another product from a second seller. All purchases made using the buyer service 302 is routed through the platform provider service to access the approved line of credit. Because of the centralized nature of the platform provider service 304, a single order can be created. Once an order is created, it is sent to the platform provider service 304.

At step 330, the platform provider service 304 validates and determines that the buyer has sufficient credit available to complete the order. Upon validation, at step 332 a real-time webhook sent by the platform provider service 304 initiates a series of actions at the seller service 306 end, causing the seller service to fulfill the order. The seller service 306 can then ship the order at step 334 and at step 336, the platform provider service can capture the shipping information including final costs and delivery dates. The platform provider service 304 is then able to generate an invoice to be sent to both the buyer service 302 and the lending service 308.

The lending service 308 receives the invoice for the completed and fulfilled order at step 340. The lending service 308 can then initiate a secure financial transfer to pay the seller service 306 for the items and services purchased by the user with the line of credit. This financial transfer is facilitated through secure API calls ensuring financial compliance and security. Additionally, the lender service can disperse to the seller service 306 through secure banking channels. This is achieved through secure banking channels. Following the financial closure, at step 346 a detailed remittance file is generated through a batch process or API call at the lender service 308 and transmitted to the platform provider service 304 delineating the payment details.

At step 338, the buyer service 302 can receive an invoice that reflects the seller's brand aesthetics and details. The ability to personalize the invoice to such a degree is facilitated by the sophisticated mechanisms embedded within the platform provider service 304. The platform provider service 304 is configured with a dynamic template engine that allows for the generation of invoices that resemble and mimic the seller's brand identity. For example, the engine can identify various elements such as the seller's logo, branding colors, font types, and other thematic identifiers from a database where the sellers' branding assets are stored. Moreover, the system is capable of seamlessly incorporating dynamic data into the invoice template, referring to the specifics of the transaction, including but not limited to item details, pricing breakdown, and shipping information. This is achieved through real-time data fetching and rendering scripts that populate the invoice template with the most recent and accurate data, ensuring the precision of the information presented in the invoice. Furthermore, the platform provider service 304 is structured to support multi-language and multi-currency options.

In the context of generating invoices with thematic identifiers that resonate with the seller's brand identity, an example technology can use a machine learning algorithm that takes into consideration an array of distinctive elements such as the seller's logo, branding colors, font types, and other thematic identifiers. The initiative starts with the amalgamation of a substantial dataset comprising diverse invoice templates illustrating a myriad of styles and thematic elements.

At step 340, the platform provider service 304 receives payment from the buyer service 302 wherein the buyer settles the invoice generated in the previous step. This payment is directed towards the platform provider service 304, acting as an intermediary financial handler streamlining the financial transactions between various entities involved in the process. The platform provider service 304 maintains a meticulous record of all transactions facilitated, fostering transparency and enabling easy audit trails. The transaction details are stored in secure databases.

Moving to step 348, after confirming the receipt of the payment from the buyer service 302, the platform provider service 304 proceeds to initiate the payment process directed towards the lending service 308. This step is carried out leveraging secure and optimized API calls which not only facilitate a safe transmission but also ensure a rapid transaction process, meeting the financial compliance requisites, and adhering to the regulatory frameworks in place globally. Additionally, a validation process where the details of the transaction are corroborated to rule out any discrepancies is used during this step. The system leverages automated reconciliation tools integrated with AI modules, which scrutinize the transaction details against the set parameters and historical data, fostering a system grounded in accuracy and reliability. Further, any of this data can be converted into a standardized format for use in the processes described herein.

In the operational framework described above, deep learning and big data analytics can be used to standardize and analyze data. In some examples, the services use NLP techniques to convert unstructured datasets into structured formats, establishing a reliable base for further analytical procedures. Additionally, data retrieved at any step herein may be in a plurality of formats. Any one of the services can covert the data from any one of the plurality of formats into a standardized format. In some examples, in step 314, the system leverages predictive analytics based on AI methodologies to implement a dynamic risk assessment protocol. This protocol encompasses a broader set of variables compared to traditional models, utilizing a rich dataset to evaluate an applicant's creditworthiness dynamically. It integrates real-time market insights and employs anomaly detection functionalities to maintain system security.

The integration phase involving buyer service 302 at steps 324-326 and lending service 308 leverages big data analytics to synthesize information from a spectrum of sources. Here, data mining techniques are employed to form a consolidated repository, enriched with insights derived from both structured and unstructured data. Deep learning models facilitate intelligent segmentation of applicants, enhancing the procedure delineated in step 314 through real-time predictive modeling. Additionally, at steps 324-326, the system incorporates scenario analysis to anticipate a variety of economic contingencies potentially affecting lending terms. It harmonizes deep learning, AI, and big data analytics to create a resilient and adaptive process that leverages technology to forge a future-proof, data-driven financial landscape.

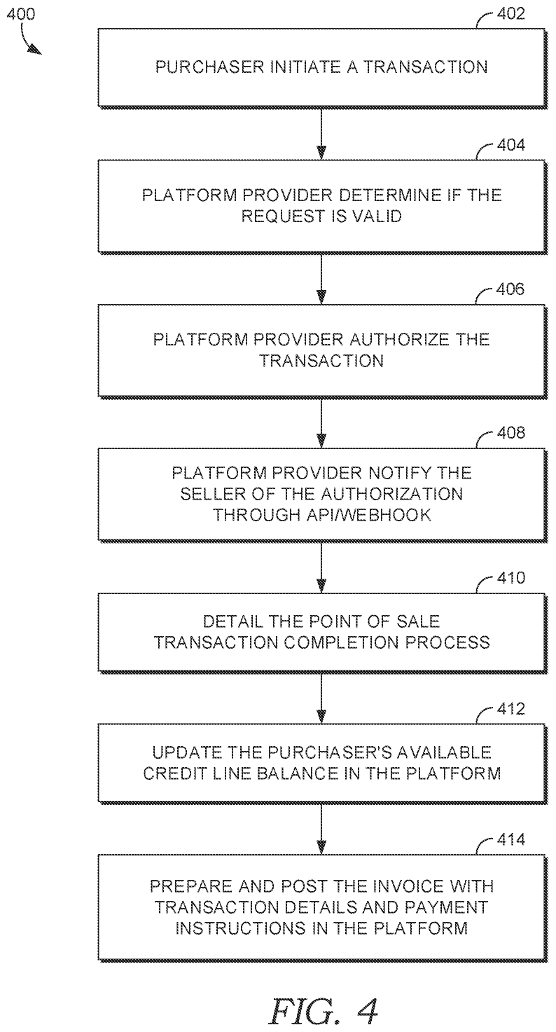

FIG. 4 illustrates an example method 400 for processing a credit application, in accordance with an aspect described herein. FIG. 4 is designed to depict the transaction authorization and notification process using a platform provider service such as platform provider service 304 described in reference to FIG. 3. At block 402 the purchaser initiates a transaction, essentially setting the entire process in motion. This initiation involves the purchaser taking actions such as selecting goods or services, adding them to a cart, and proceeding to the payment or checkout phase. This step establishes the intent to conduct a transaction by the buyer.

Subsequently, at block 404 the platform provider service validates the request. This block 404 involves a analyzing the transaction details to affirm its validity, which may encompass scrutinizing the availability of the selected items and the availability of funds within the buyers credit limit at a particular lender. Further, at block 406, the platform provider authorizes the transaction to proceed based on the validity determination. Having secured authorization, the platform provider, at block 408, then notifies the seller regarding the approved status of the transaction via a secure API/Webhook pathway. This communication serves to update the seller on the transaction's readiness to be fulfilled, instigating the necessary actions on the seller's end to facilitate the transaction. At block 510, the transactions' details at the point of sale are documented. This provides a comprehensive record of elements involved in the transaction. Such details can be item details, total transaction value, and applicable taxes, credit remaining, shipping details, transit details, customs information, among other details.

Upon the transaction completion at block 412, the platform updates the purchaser's available credit line balance, reflecting the new balance post the recent transaction. In block 414, the platform generates an invoice outlining every detail about the transaction coupled with clear payment instructions. This invoice is then populated on the platform, rendering a well-defined pathway for the purchaser to adhere to while settling the payment. The invoice is also sent to the lender causing the lender to generate payment to the seller. Additionally, once the buyer provides payment to the platform, based on the invoice, the platform can then automatically provide payment to the lender to resolve the debt created by the transaction.

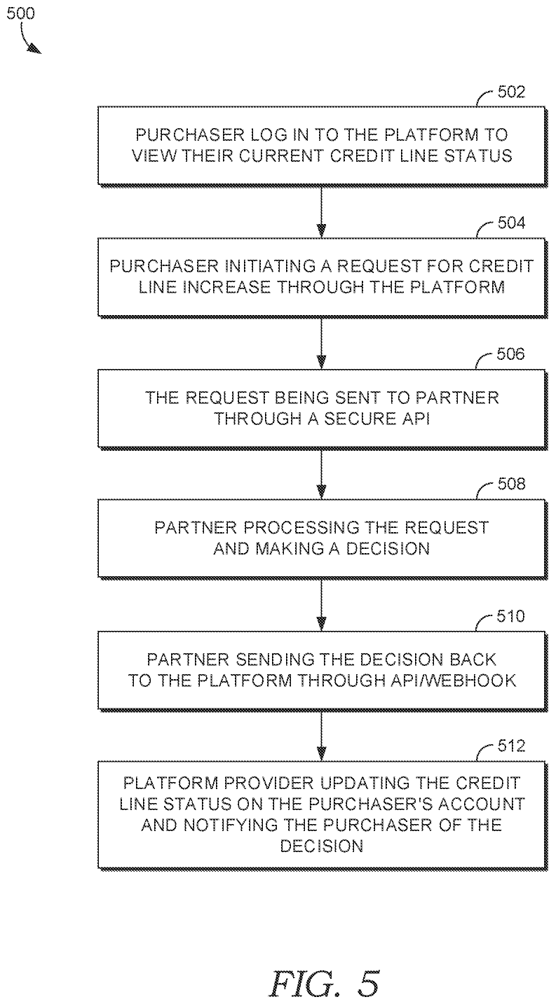

FIG. 5 illustrates an example method 500 for processing a credit application, in accordance with an aspect described herein. FIG. 5 is designed to depict the transaction authorization and notification process using a platform provider service such as platform provider service 304 described in reference to FIG. 3. At block 502, the purchaser can provide their login credentials to access the platform. Once logged in, they can inspect their current credit line status, providing a clear insight into their available credit resources.

Following a review of their current credit line status, at block 504 the purchaser can initiate a request for a credit line increase directly through the platform. This step allows the purchaser to propose an adjustment to their credit limit, illustrating a proactive engagement with their financial portfolio. Subsequently, in block 506, the platform transmits the purchaser's request for a credit line increase to the associated lending partner utilizing a secure API channel.

Upon receiving the request, the lending partner processes it in block 508. This involves evaluating the purchaser's creditworthiness based on various parameters such as their credit history, transaction behavior, and existing credit line usage. Following an analysis, the partner reaches a decision on whether to approve or decline the credit line increase request. In block 510, the lending partner communicates their decision back to the platform, utilizing the API/Webhook pathway. This feedback loop ensures that the platform is updated promptly on the resolution regarding the credit line increase request, establishing a swift communication channel between the partner and the platform.

Finally, in block 512, the platform provider assumes the duty of updating the purchaser's account with the new credit line status dictated by the partner's decision. Simultaneously, the purchaser is notified about this decision, creating a transparent environment where they are kept abreast of the developments in real-time. Moreover, the platform is prepared to generate and post a detailed transaction invoice, further establishing a clear documentation trail and facilitating the ease of future references.

Embodiments described above are combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present disclosure is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having,” or variations thereof, has the same broad meaning as the word “comprising,” and the word “accessing,” or variations thereof, and comprises “receiving,” “referencing,” or “retrieving.” Further, the word “communicating,” or variations thereof, has the same broad meaning as the word “receiving” or “transmitting” facilitated by software or hardware-based buses, receivers, or transmitters using communication media. Also, the word “initiating” or “invoking,” or variations thereof, has the same broad meaning as the word “executing” or “instructing” where the corresponding action can be performed to completion or interrupted based on an occurrence of another action.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of a detailed discussion above, embodiments of the present disclosure are described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present disclosure may generally refer to the distributed data object management system and the described schematics, it is understood that the techniques described may be extended to other implementation contexts.

From the foregoing, it will be seen that the present disclosure may be well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated in the accompanying drawings is to be interpreted as illustrative and not in a limiting sense.

What is claimed is:

1. One or more non-transitory computer storage media storing computer-readable instructions that, when executed by one or more processors, cause the one or more processors to perform operations for a user application, the operations comprising:
receiving, by a processor, a request to authorize a user, the request to authorize comprising a plurality of application data;
retrieving, by the processor from a database, a plurality of metrics associated with the user, wherein the plurality of metrics are in a plurality of formats;
converting, by the processor, each of the plurality of metrics from the plurality of formats into a first standard format;
generating, by the processor, a risk metric score based on the plurality of metrics in the first standard format, the risk metric score being generated by a machine learning algorithm;
selecting a first lender based on the plurality of metrics and a predetermined set of criteria;
communicating through a secure communication protocol, by the processor, the risk metric score to the first lender;
receiving through the secure communication protocol, by the processor, from the first lender an approval of the user based on the risk metric score;
automatically generating terms and conditions for a lending agreement, wherein the terms and conditions are based on the plurality of metrics and a set of predefined rules of a lending agreement generating algorithm; and
automatically causing a execution of the lending agreement by way of a smart contract.

2. The one or more computer storage media of claim 1, wherein the plurality of metrics retrieved from the database include at least one of a user's credit score, transaction history, and payment history.

3. The one or more computer storage media of claim 1, herein the machine learning algorithm uses a neural network trained to analyze and interpret the plurality of metrics.

4. The one or more computer storage media of claim 1, further comprising authenticating the user based on a multi-factor authentication process before receiving the request to authorize the user.

5. The one or more computer storage media of claim 1, wherein the secure communication protocol employed is based on transport layer security (TLS) or secure sockets layer (SSL) protocols, facilitating end-to-end encryption and data integrity checks.

6. The one or more computer storage media of claim 1, wherein the predetermined set of criteria for selecting the first lender includes a first lender's preferences, financial thresholds, and lending history.

7. The one or more computer storage media of claim 1, wherein one or more pre-defined rules of the lending agreement generating algorithm are adaptable based on regulatory requirements and changes in market conditions.

8. The one or more computer storage media of claim 1, wherein the smart contract for executing the lending agreement is configured to automatically execute predetermined actions when specified conditions are met, facilitating a self-executing agreement.

9. The one or more computer storage media of claim 1, further comprising notifying the user through a secure channel regarding a status of their application and details of the lending agreement upon receiving of the approval from the first lender.

10. A method for a user application performed by one or more processors, the method comprising:
receiving an authorization from a lender to initiate the use of one or more services provided by the lender;
using a machine learning algorithm to analyze historical data and user metrics, generating a set of terms and conditions, wherein the set of terms and conditions are defined based on predictive analysis of a user risk metric score and lender preferences;
generating, a lending contract, based on the set of terms and conditions;
communicating the lending contract to the lender and the user;
receiving an indication that the user and the lender approve of the lending contract; and
causing the lending contract to be executed automatically using a smart contract platform to finalize the lending contract between the user and the lender.

11. The method of claim 10, wherein the machine learning algorithm is further adapted to continually learn and update the machine learning algorithm for generating the set of terms and conditions based on historical performance of previously executed contracts.

12. The method of claim 10, wherein the historical data and user metrics analyzed by the machine learning algorithm include data selected from a group consisting of: credit score, repayment history, income details, employment status, and one or more previous loan details.

13. The method of claim 10, wherein the smart contract platform is configured to automatically facilitate various actions related to the lending contract, including but not limited to: disbursement of funds, installment tracking, notifications to the user and lender, and automatic deductions for repayments according to the lending contract.

14. The method of claim 10, wherein the communication of the lending contract to the lender and the user is facilitated through secure channels, incorporating end-to-end encryption.

15. The method of claim 10, further comprising a step of receiving feedback from both the lender and the user, wherein the feedback is utilized to further train the machine learning algorithm.

16. A system comprising:
at least one processor; and
one or more computer storage media storing computer-readable instructions thereon that, when executed by the at least one processor, cause the at least one processor to:
receive a request to initiate a lending process, the request including application data pertaining to a user;
retrieve a plurality of metrics associated with the user from a database, wherein the plurality of metrics associated with the user have a plurality of disparate formats;
transform the plurality of metrics from a plurality of data formats into a standardized data set;
generate, using a machine learning algorithm and the standardized data set, a risk metric score;
automatically determine, based on the risk metric score, that the user is authorized to use one or more services of a first lender; and
communicate an authorization decision to a graphical user interface, indicating that the user is authorized to use the one or more services of the first lender.

17. The system of claim 16, wherein the machine learning algorithm is configured to iteratively learn by analyzing results of previous authorization decisions.

18. The system of claim 16, wherein the graphical user interface provides a user-friendly interface for accessing and using services of the first lender.

19. The system of claim 16, further comprising a step of receiving feedback from both the first lender and the user, wherein the feedback is utilized to further train the machine learning algorithm to optimize the risk metric score.

20. The system of claim 16, wherein the communication of the authorization decision to the user is facilitated through secure channels, incorporating end-to-end encryption.
